(19) United States
(12) Patent Application Publication
(10) Pub. No.: US 2005/0066740 A1
(43) Pub. Date: Mar. 31, 2005

(54) Laboratory wear and drag force testing system

(75) Inventor: Kevin R. Willett, Maryville, TN (US)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York City, NY (US)

(21) Appl. No.: 10/670,827

(22) Filed: Sep. 25, 2003

(51) Int. Cl. G01N 3/08

(52) U.S. Cl. 73/818

(57) ABSTRACT

A laboratory wear and drag force testing system in a central controller operably connected to a plurality of testing terminals. The testing terminals allow for environmental isolation of the drive mechanisms to allow a range of testing temperatures. Both vertical and horizontal loads are measured and recorded such that testing can be suspended or terminated in response to predetermined thresholds.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “SEQUENCE LISTING”

Not applicable.

### BACKGROUND OF THE INVENTION

1. Field of the Invention

The present invention relates to laboratory wear and drag force testing equipment, and particularly to a system for testing the effects of continuous or intermittent contact between a selected media and a test sample, and more particularly, to a system for testing wear and drag forces of media typically associated or employed in automotive vehicles such as glass, fabrics and paints against vehicular seals and sealing surfaces.

2. Background Art

The repeated contact of seal surfaces in automotive vehicles, such as those typically associated with doors and windows, has prompted the auto industry to set certain standards and thresholds for surfaces employed in these repeated contacts. The standards and thresholds are usually limited to and defined in terms of specific wear and/or abrasion testing equipment. Further, the available testing systems were often developed for different industries, and thus not designed to accommodate the unique aspects of automotive components. Existing wear testing equipment typically provides for moving one surface with respect to another under certain conditions to determine a resulting change or interaction between the surfaces. However, resulting data and hence standards and thresholds are often machine dependent. Such machine dependence reduces the reproducibility of any results. In addition, any non-uniformity of test results can lead to undesirable performance of the resulting seals, or materials.

Therefore, the need exists for a testing system that can provide reproducible results so that remote geographic or temporal testing provides meaningful and comparable data. The need also exists for a laboratory wear and drag force testing system that can accommodate a plurality of different test samples as well as abrasive media, without requiring extensive retooling. The need further exists for a testing system that can simultaneously control and monitor a plurality of testing parameters. A need exists for a testing system that can allow interruptions within a test run, without jeopardizing the resulting data or subsequent data.

### BRIEF SUMMARY OF THE INVENTION

The present laboratory wear and drag force testing system can be used to determine the drag force between selected test samples and contacting media, wherein the parameters of the contact can be controlled and monitored. The testing system allows for controlling a variety of contact parameters for a range of materials including relatively abrasive materials and contact surfaces often employed in vehicles, such as seals and sealing surfaces, wherein the sealing surfaces can include coatings. The testing system can employ any of a variety of abrasive media such as, but not limited to abrasive papers, abrasive cloth, glass panels and painted panels against a variety of test samples, such as but not limited to seals and coatings. Further, the present testing system allows for applying and monitoring variable loads, between different test runs as well as within a given test run. In addition, the present system can monitor each of the test parameters throughout the test run and can dynamically alter the test parameters, without requiring operator intervention. The present testing system can provide feedback responsive testing parameter modification. Thus, the testing system can provide accelerated testing protocols to determine anticipated product longevity. Further, the present testing system allows testing that is representative of actual wear to which the product will be subjected in use. A further configuration of the testing system isolates portions of the system, so that test samples can be exposed to a range of environmental conditions without jeopardizing critical components of the testing system.

In one configuration, the present testing system includes a plurality of testing terminals operably connected to a central controller. Each testing terminal includes a base with a drive assembly connected to the base, wherein the drive assembly includes a horizontal drive and a vertical drive. A load cell is associated with each of the horizontal drive and the vertical drive for monitoring the loads associated with each relative motion and hence drag force.

The drive assembly can include a media mount for releasably and repeatedly retaining a selected media for test. Further, the media mount provides for operator manipulation without requiring secondary tools.

In a preferred configuration, the testing terminal includes an isolating housing for providing a substantially sealed environment surrounding the drive assembly, wherein a portion of the media mount projects from the isolating housing. Thus, the drive assembly can be maintained at relatively stable operating conditions, while the media mount and test sample can be exposed to a variety of environmental conditions, including temperature and humidity ranges.

The testing terminal can further include a test piece positioner generally fixed relative to the base for retaining the test sample in an operable location relative to the media mount. Similar to the media mount, the test piece positioner allows for the repeated and reproducible positioning of the test sample. In addition, the test piece positioner allows for engaging and exchanging test samples without requiring tools.

The central controller is operably connected to the plurality of testing terminals and allows for setting or adjustment of test parameters including, but not limited to, stroke length, cycle rate, total cycles, load sensing as well as termination parameters. The central controller is also operably connected to the load cells to provide a feedback loop. Thus, the control of certain testing parameters can be modified in real time within a test run, in response to acquired data without requiring operator intervention.

### BRIEF DESCRIPTION OF THE SEVERAL VIEWS OF THE DRAWING(S)

FIG. 1 is a perspective view showing a central controller operably connected to a plurality of testing terminals.

FIG. 2 is a perspective view of the testing terminal, with alternative media mounts and test sample mounts.

FIG. 3 is an exploded perspective view of a testing terminal.

FIG. 4 is a perspective view of the horizontal drive of the testing terminal.

FIG. 5 is a perspective view of vertical drive.

FIG. 6 is an exploded perspective view of the vertical drive.

FIG. 7 is a perspective view of a first configuration of a media mount.

FIG. 8 is an exploded perspective view of the media mount of FIG. 7.

FIG. 9 is a perspective view of an alternative abrasive media mount.

FIG. 10 is an exploded perspective view of the alternative abrasive media mount of FIG. 9.

FIG. 11 is a perspective view a further media mount configuration.

FIG. 12 is an exploded perspective view of the media mount of FIG. 11.

FIG. 13 is a perspective view of a test piece positioner.

FIG. 14 is an exploded perspective view of the test piece positioner of FIG. 13.

FIG. 15 is a perspective view of a test sample mount.

FIG. 16 is a perspective view of a vacuum assisted test sample mount

FIG. 17 is an exploded perspective view of the vacuum assisted test sample mount of FIG. 16.

FIG. 18 is a perspective view of an alternative test sample mount.

### DETAILED DESCRIPTION OF THE INVENTION

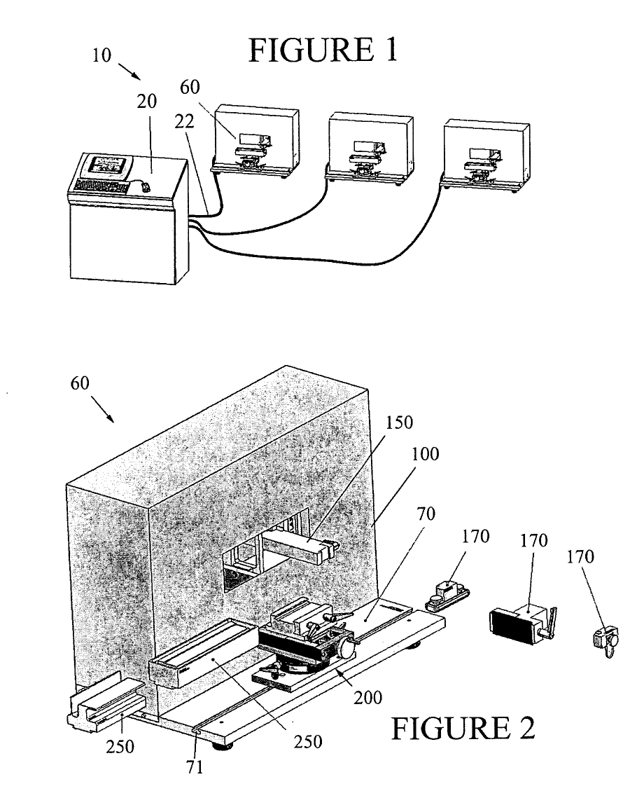

Referring to FIG. 1, the present laboratory wear and drag force testing system 10 includes a central controller 20 and a plurality of testing terminals 60.

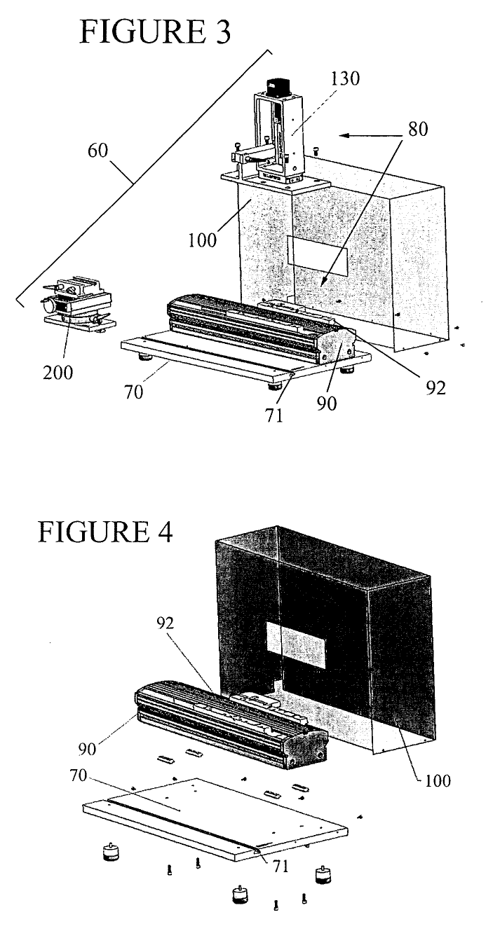

Referring to FIGS. 2 and 3, each testing terminal 60 includes a base 70, a drive assembly 80 connected to the base, and a test piece positioner 200.

As seen in FIGS. 2-4, the base 70 is a generally planar rigid member, typically formed of a machinable metal or composite. The base 70 includes an elongate capture groove 71 such as a T-slot. In addition, the base 70 includes fastening apertures or fixtures for cooperatively engaging the respective components of the testing system 10.

The drive assembly 80 is operably connected to the base 70 for movement relative to the base, and includes a horizontal drive 90, a vertical drive 130 and a media mount 170.

The horizontal drive 90 is connected to the base 70 and includes a carriage 92, wherein the carriage is selectively moved in a reciprocating motion along an axis, typically configured to be horizontal. The horizontal drive 90 can be any of a variety of constructions, such as mechanical drives, belt drives, hydraulic, pneumatic or even magnetic drives. A satisfactory drive is a linear actuator. As seen in FIGS. 3 and 4, the carriage 92 can have any of a variety of configurations and is operably connected to the linear actuator for movement as dictated by linear actuator. A satisfactory horizontal drive 90 is a servo actuator assembly THK LSA-072-646, such as manufactured by THK Co. Ltd.

Although the horizontal drive 90 can have any of a variety of operating parameters and capabilities, a satisfactory range of reciprocating motion along the axis has been found to be between 1 and 600 cycles per minute with an adjustable stroke length of approximately 1 mm to approximately 200 mm.

Referring to FIG. 3, the vertical drive 130 is connected to the carriage 92 of the horizontal drive 90 and includes a carriage mounting plate 132, a vertical support frame 140, a mounting arm 150 and a vertical actuator 160.

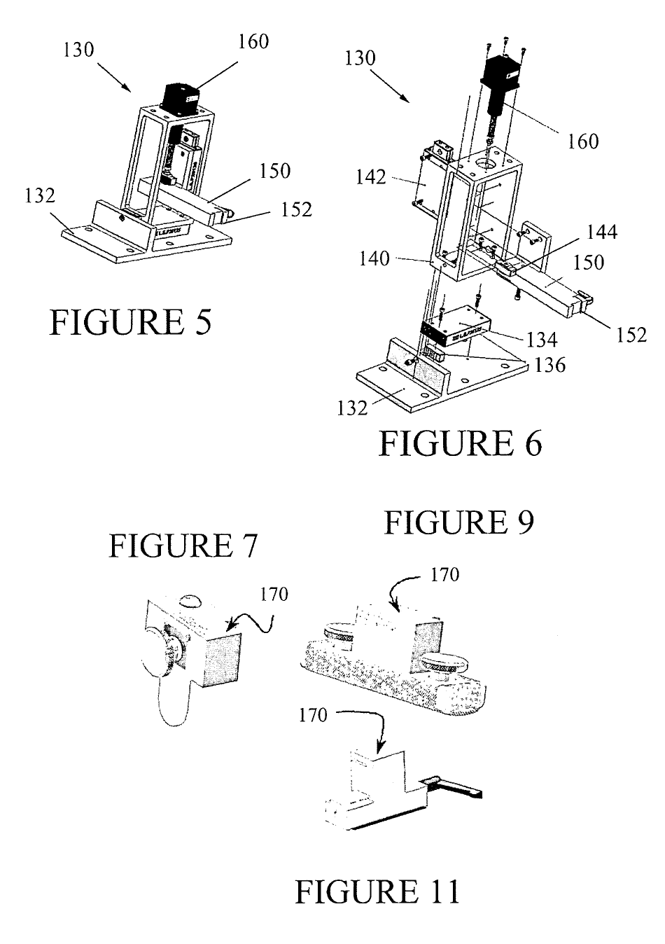

As seen in FIGS. 5 and 6, the carriage mounting plate 132 is affixed to the carriage 92 of the horizontal drive 90 for motion therewith.

A linear bearing 134 operably interconnects the vertical support frame 140 and the carriage mounting plate 92. The linear bearing 134 is oriented to permit relative motion between the carriage mounting plate 92 and the vertical support frame 140 along the axis of the reciprocating motion of the horizontal drive 90. Further, a tension/compression load cell 136 is operably disposed in cooperation with the linear bearing 134 between the carriage mounting plate 92 and the vertical support frame 140. The tension/compression load cell 136 is located to provide a signal corresponding to a relative force between the carriage mounting plate 92 and the vertical support frame 140, and thus a load or resistance to horizontal motion of the vertical support frame along the axis of the horizontal drive.

The mounting arm 150 is cooperatively engaged to the vertical support frame 140 by a second linear bearing 142. The second linear bearing 142 is oriented to permit movement along an axis perpendicular to the axis of reciprocating motion of the horizontal drive 90. Thus, the motion of the drive assembly 80 is limited to a single horizontal component and a single vertical component.

The vertical actuator 160 is affixed to the vertical frame 140 and operably connected to the mounting arm 150 for moving the mounting arm in the vertical direction as guided by the second linear bearing 142. A satisfactory vertical actuator 160 has been found to be a Series 5700 Size 23 Captive Shaft actuator from Haydon Switch and Instrument of Waterbury, Conn. Preferably, a second tension/compression load cell 144 is interconnected between the vertical actuator 160 and the mounting arm 150. The tension/compression load cell 144 provides a signal corresponding to a vertical loading or force on the mounting arm 150, (and hence between the media and test sample).

The vertical drive can thus provide a variable and controllable applied force, or load. A satisfactory range capacity of the vertical actuator 160 has been found to be from approximately 100 grams to 7 kilograms. However, it is understood that alternative ranges of the applied force can be obtained from alternative actuators or intermediate gearing.

The mounting arm 150 projects from the vertical support frame 140 and includes a quick connect (toolless) interconnection 152 for operably engaging and disengaging any of a plurality of the media mounts 170. As shown in the figures, the media mount 170 and the mounting arm 150 can include cooperating dovetail tongue and grooves, with quick release clamping mechanisms 152.

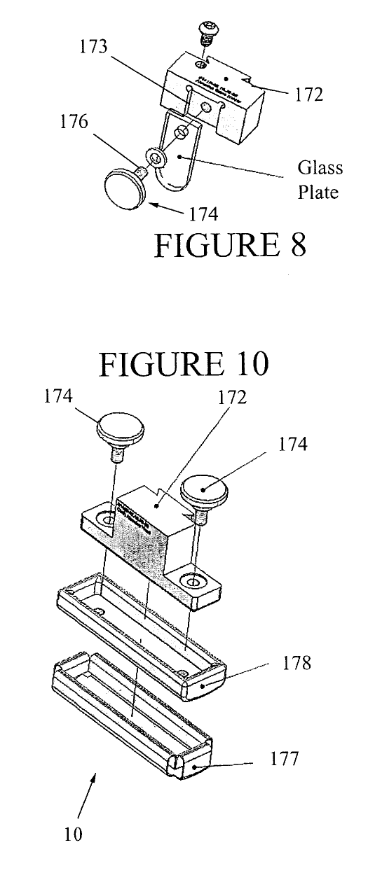

The media mounts 170 can be configured to operably retain any of a variety of media such as glass, fabrics or painted panels. Referring to FIGS. 8-12, a variety of media mounts 170 are shown. As seen in FIGS. 8 and 9, a media mount 170 for retaining a glass plate includes a mount block 172 having a corresponding dove tail feature for engaging the mounting arm 150. Further, the mount block 172 includes a recess 173 sized to engage a portion of a periphery of the glass plate to locate the plate relative to the mount block. The recess 173 includes a threaded receptacle. Preferably, the glass plate includes a locating aperture, wherein a retaining knob 174 includes a threaded post sized to pass through the locating aperture and engage the threaded receptacle. As the periphery of the glass plate contacting the recess 173 is substantially free of wear, the glass plate can be reproducibly located within the recess. The retaining knob 174 engages the mount block 172 to retain the glass plate in the desired position.

As seen in FIGS. 9 and 10, the media mount 170 again includes a mount block 172 having a corresponding dove tail feature for engaging the mounting arm 150. In this configuration, the media mount 170 further includes a fabric backer 178 sized to receive a portion of the mount block. Fabric 177 is trapped between the fabric backer 178 and the mount block 172, wherein the retaining knobs 174 urge the fabric backer and the mount block together to retain the fabric relative to the mount block.

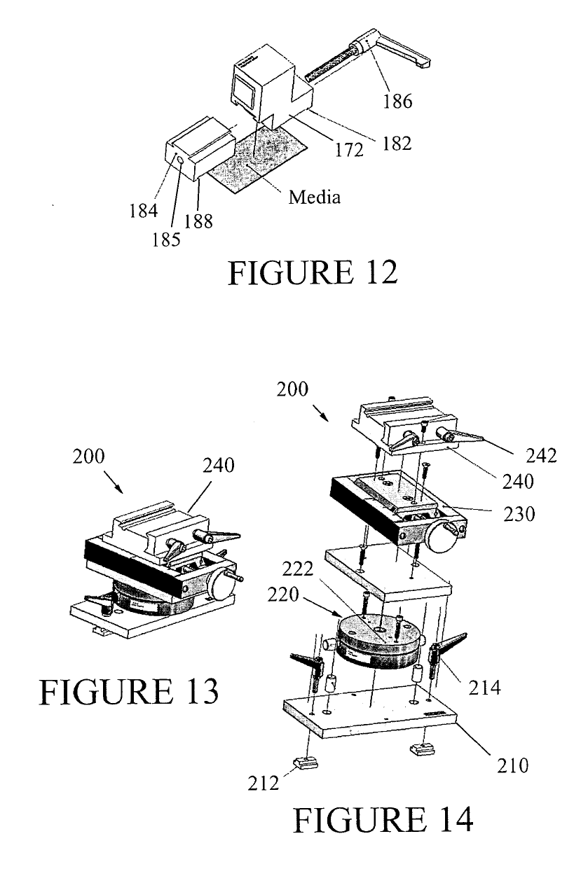

As seen in FIGS. 11 and 12, the media mount 170 includes the mount block 172 for engaging the mounting arm 150. In this configuration, the mount block 172 includes a retaining shoulder 182, a through aperture and a cooperating capture block 184. The capture block 184 and the mount block 172 include cooperating dovetails for guided relative movement. The capture block 184 includes a threaded recess 185 and a capture shoulder 188, wherein a quick release threaded fastener 186 extends through the aperture in the mount block 172 to engage the threaded recess 185. A painted (or otherwise treated, or bare) media can thus be retained between the capture shoulder 188 and the retaining shoulder 182.

Preferably, the media mount 170 and the mounting arm 150 cooperatively engage in a fixed and repeatable position such that operator adjustability is limited to applying a clamping force rather than relative positioning. That is, each time the media mount 170 is engaged with the mounting arm 150, the media mount assumes the same position. Thus, the media can be reproducibly and repeatably located. Therefore, as the media may wear during a testing cycle, thereby adversely affecting the data, replacement or repaired media can be operably located relative to the test sample with significantly degrading subsequent data.

Referring to FIGS. 2-4, an isolating housing 100 substantially encloses the drive assembly 80 and a portion of the media mount 150. The housing 100 can include an insulating layer, be formed of an insulating material, or both so as to permit maintenance of a desired temperature within housing. As seen in FIG. 2, the isolating housing 100 and the mounting arm 150 are sized such that a portion of the mounting arm projects from the housing, wherein the media mount 170 is disposed exterior to the housing.

Preferably, a seal is formed about the mounting arm 150 to extend to the housing 100, so as to allow movement of the mounting arm relative to the isolating housing 100. Depending upon the intended operating parameters of the testing system 10, the seal can be any of a variety of configurations, such as but not limited to bellows, gaskets or brush seals. Thus, the mounting arm 150 can move as directed by the drive assembly 80 (in both the horizontal and vertical axes), yet a substantially sealed interface is maintained between an interior of the housing 100 and an exterior of the housing. Thus, the testing terminal 60 can be disposed in any of a variety of environments including high or low temperature as well as different humidities and acidities, wherein the drive assembly 80 is substantially shielded from the testing environment.

The isolating housing 100 can include or encompass a number of environmental sensors, such as but not limited to temperature sensors and humidity sensors, wherein the sensors are located to measure conditions inside the housing and outside the housing.

It is further contemplated that a controlled atmosphere can be maintained in the interior of the isolating housing 100 by any of a variety of mechanisms, including heating a cooling elements located within the housing. Alternatively, the controlled environment can be maintained through the introduction of heated or cooled air to the interior of the isolating housing 100, such that the introduced air at least partially pressurizes the housing to maintain the desirable operating parameters for the drive assembly 80.

Preferably, the seal of the isolating housing 100 allows the testing terminal to be operated within a temperature range from approximately −40° C. to 80° C. That is, the drive assembly 80 can remain functioning in an intended manner, while the test sample is exposed to the temperature range.

Referring to FIGS. 13 and 14, the test piece positioner 200 is connected to the base 70 and cooperatively retains the test sample relative to the base. The test piece positioner 200 is external to the isolating housing 100.

The test piece positioner 200 includes a mounting plate 210, a turntable 220, a slide assembly 230 and a mounting anvil 240.

The mounting plate 210 cooperatively engages the base 70 by means of a nut 212 sized to be received within the T-slot 71 in the base. Preferably, the mounting plate 210 can be fixed relative to the base 70 by a quick release mechanism 214 which clamps the nut 212 within the T-slot 71. Thus, the mounting plate 210, and hence test piece positioner 200 can be located at any of a variety of horizontal positions relative to the drive assembly 80.

The turntable 220 is connected to the mounting plate 210 and includes an upper rotatable platter 222. Thus, the turntable 220 allows the test piece positioner 200 to provide any of a variety of angular orientations relative to the axis of motions of the drive assembly 80.

The slide assembly 230 is operably connected to the rotatable platter 222 for allowing horizontal motion. The slide assembly 230 provides a range of motion along a horizontal direction, and depending upon the orientation of the turntable 220, the direction of travel can be parallel to the axis of horizontal motion of the drive assembly 80 or transverse to the horizontal motion of the drive assembly.

The mounting anvil 240 is connected to the slide assembly 230 for cooperatively connecting the test sample to the testing terminal 60 and hence the drive assembly 80 and the media mount 150. The mounting anvil 240 is configured to releaseably engage the test sample mounts 250. The mounting anvil 240 preferably includes a quick release mechanism 242 for engaging the test sample mount 250, without requiring secondary tools.

Similar to the mounting arm 150 and the media mount 170, the mounting anvil 240 and the test sample mount 250 include cooperative fittings such as slides or dove tails, wherein the quick release mechanism 242 of the mounting anvil can be used to repeatably and reproducibly retain the test sample mount.

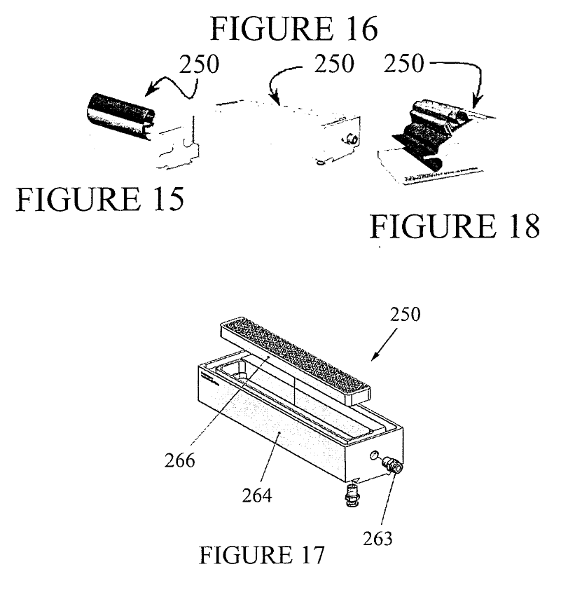

Referring to FIGS. 15-18, the test sample mount 250 can have a variety of configurations for operably locating the test sample relative to the media. For example, in FIG. 15, the test sample mount 150 includes horizontally and vertically oriented flanges, wherein flange-engaging strips and covers can be mounted on the desired flange.

With respect to FIGS. 16 and 17, the test sample mount 250 can be configured as a vacuum mount 262, wherein alternatively shaped test samples can be retained by means of a vacuum. As seen in FIG. 17, the vacuum mount 262 includes a mounting plate 264 and a vacuum plate 266 moveable relative to the mounting plate by means of an applied reduced pressure. The vacuum mount 262 further includes a vacuum port 263 for selective connection to a source of reduced pressure.

As seen in FIG. 18, sample specific features can be formed on the test sample mount 250 to accommodate any of a variety of test sample configurations, wherein the sample mount need only have a cooperative fitting for being received in the mounting anvil 240.

In addition, each testing terminal 60 can include a liquid dispenser for selectively applying a liquid to the test sample, either before or during a test run. The liquid dispenser can be any of a variety of configurations as know in the art, including but not limited to drips, mists, sprays, washes, wicks or pumps. The housing 100 substantially isolates the drive assembly 80 from the liquid. Thus, the testing terminal 60 allows for testing under influence of liquid solutions.

Although the drive assembly 80 has been described with the vertical drive 130 being translated by the horizontal drive 90, it is understood the vertical drive can be incorporated with the test piece positioner 200. However, such configuration may expose portions of the drive to adverse testing conditions.

The drive assembly 80 can provide reciprocating motion along two perpendicularly intersecting axes. However, it is understood the axes of motion can be non-perpendicular, and thus the forces can be resolved to provide the necessary data. Similarly, though the axes of motion are shown as being coplanar, the axes can lie in separate parallel planes, or separate intersecting planes.

Further, although the present configurations have been described in terms of a linear contact path between the media and the test sample, it is understood that any of a variety of nonlinear contact paths, such as circular, elliptical, oval or figure eights could be employed. Similarly, at least one additional axis of motion could be provided, wherein the motion is controlled and any applied or resistive force is measured.

Preferably, each testing terminal 60 provides a stable securing of the test sample relative to the drive assembly 60. Further, the testing terminal 60 provides an accurate and stable means for applying a known force (weight) to the test sample. The testing terminal 60 also provides for operable connection with any of a variety of samples through corresponding test sample mounts 250.

The central controller 20 is operably connected to the plurality of test terminals 60 and in turn, can be connected to a local or global network. The central controller 20 can be operably connected to the plurality of testing terminals 60 by any of a variety of mechanisms including, but not limited to cabling 22, as well as wireless connections. The central controller 20 is operably connected to the horizontal drive 90, the vertical drive 130, the associated load cells 136, 144, as well as any sensors at the testing terminal 60. The central controller 20 includes sufficient memory and data storage for capturing data at any of a variety of predetermined or test specific intervals. Preferably, the central controller 20 includes an input such as a touch screen or keyboard, but is understood that pointers and/or hand associated devices can be used. The central controller 20 can be either a dedicated processor or a programmed computer, such as a desktop or personal computer. The central controller 20 includes or is operably connected to a data storage device.

The central controller 20 is configured to operably monitor and control the plurality of testing terminals 60. The number of testing terminals 60 is at least partially determined by the amount of testing to be performed and the processing capacity of the central controller.

Preferably, the central controller 20 can control the variable stroke rate of the horizontal drive 90, for example, but not limited to 1 to 600 strokes per minute, in 1 stroke per minute increments. Further, the central controller 20 can control each of the variable stroke lengths of the horizontal drive 90 each of the testing terminals 60 from 1 to 200 mm in 1 mm increments. Although the testing terminals 60 are shown as separate physical structures, it is understood a plurality of testing terminals can be encompassed within a single housing 100.

Further, the central controller 20 can actively control the vertical actuator 160 to provide the selected variable loads for each testing terminal 60.

As each of the load sensors 136, 144 is operably connected to the central controller 20, measurement and recording of the drag force, load force or coefficient of friction (COF) wherein inertia compensation can be provided. The inertia compensation accounts for different masses of the different media mounts 170, which could otherwise adversely influence the calculations corresponding to the signals from the load cells.

By use of the central controller 20, the present testing system 10 can be adapted to perform any type of test associated with abrasion and/or drag force measurement. The tool-free interchangeable abrasion and drag force media mounts 150 along with the universal and sample specific mounts allow the testing system 10 to conduct general or real world simulation testing. By controlling and monitoring both axes of motion, the present testing system 10 can provide enhanced detail and analysis of the effects of abrasion or wear on various types of materials and coatings.

Through the central controller 20, the operator can automatically suspend a testing cycle after a predetermined drag force measurement has been reached, or a given number of cycles has been achieved, to conduct a visual inspection of the sample. By virtue of the testing system test sample positioner 200, the test samples can be relocated after inspection (and any desired measurements) and the cycling reinitiated with an enhanced accuracy and repeatability.

The central controller 20 is configured to allow flexible program design to allow for program redesign or modification. In addition, the central controller 20 applies closed-loop feedback for constant monitoring and data collection of testing parameters. It is further contemplated that the load exerted by the vertical drive can be varied within a stroke length. That is, it is believed that vehicular seals, particularly weatherseals may encounter different loading forces along different sections of the seal. The present testing system 10 can be configured to apply different loading forces at different sections of a test sample, thus providing more relevant data. It is also contemplated that the central controller 20 can be configured to compensate for thermal effects on the drive assembly 80. That is, under certain operating temperatures, the performance of the drive assembly 80 may change is measurable, or predetermined amounts. The central controller 20 can be configured to respond to a temperature signal and compensate the control signals to the drive assembly 80 and/or the resulting data.

Therefore, the testing system 10 provides for the simultaneous application and measuring (and recording, if desired) of a force and associated motion along two axes. In certain testing configurations, the applied force is exerted along one axis and a corresponding drag force (corresponding to a resistance to the reciprocating motion) is measured along the other axis. For example, a compressive applied force can be exerted by the vertical drive 130 against the test sample (determined from the signal from the load cell 144), and the drag force can be determined corresponding to the signal from the load sensor 136. That is, the horizontal drive 90 provides a controllable and measurable reciprocating drive and the vertical drive 130 provides a controllable and measurable applied force between the media sample and the test sample. Therefore, the system allows a controlled reciprocating motion to which an applied force is exerted, thereby introducing a drag force against the reciprocating motion. It is understood the compressive applied force can be controlled to be constant as the coefficient of friction between the media and the test sample changes. Alternatively, the compressive force can be varied to provide a constant or desired friction or drag force between the media and the test sample. In view of the number of available combinations, each combination is not set forth. However, it is understood that the testing system 10 allows the simultaneous application, measurement and control of a compressive force applied along at least two axes axis, while measuring or determining any associated motion along the corresponding axis.

The wear can be determined, or measured by any of a variety of mechanisms. For example, as the coefficient of friction or drag force is a function of the wear, the coefficient of friction or drag force can be used to determine wear of the test sample. Alternatively, visual inspection can be used to determine, or quantify wear. Further, the test sample can be removed from the test piece positioner 200, and subjected to surface roughness, or deformation measurements to quantify wear.

While the invention has been described in connection with a presently preferred embodiment thereof, those skilled in the art will recognize that many modifications and changes may be made therein without departing from the true spirit and scope of the invention, which accordingly is intended to be defined solely by the appended claims.

1. A testing system for determining at least one of wear and a drag force between a media and a test sample, the testing system comprising a testing terminal having a reciprocating first drive and a first load sensor for applying and measuring a first force between the media and the test sample along a first axis, and a second drive and a second load sensor for applying and measuring a second compressive force between the media and the test sample along a different second axis.

2. The testing system of claim 1, wherein at least one of the first drive and second drive has a variable stroke length.

3. The testing system of claim 1, wherein both the first drive and the second drive have a variable stroke length.

4. The testing system of claim 1, wherein at least one of the first drive and second drive has a variable stroke frequency.

5. The testing system of claim 1, wherein both the first drive and second drive have a variable stroke frequency.

6. The testing system of claim 1, wherein at least one of the first drive and the second drive is selected to provide a variable compressive force.

7. The testing system of claim 1, further comprising a central controller operably connected to the testing terminal for recording data from the testing terminal corresponding to the first force and the second force.

8. The testing system of claim 7, further comprising a plurality of testing terminals operably connected to the central controller.

9. The testing system of claim 1, further comprising a central controller operably connected to the testing terminal for controlling at least one a stroke length and a stroke frequency of the first drive and the second drive.

10. The testing system of claim 1, further comprising a central controller operably connected to the testing terminal for controlling a stroke length and a stroke frequency of the first drive and the second drive.

11. The testing system of claim 1, further comprising a central controller operably connected to the testing terminal, the central controller configured to determine a drag force between the media and the test sample.

12. The testing system of claim 1, further comprising a central controller operably connected to the testing terminal, the central controller configured to adjust a drag force by an inertia compensation.

13. The testing system of claim 1, further comprising a central controller operably connected to the testing terminal, the central controller configured to control a contact path between the media and the test sample.

14. The testing system of claim 1, further comprising a central controller operably connected to the testing terminal, the central controller configured to control an applied force between the media and the test sample along a contact path.

15. The testing system of claim 1, further comprising a central controller operably connected to the testing terminal, the central controller configured to determine a drag force between the media and the test sample along at least a portion of a contact path between the media and the test sample.

16. The testing system of claim 1, further comprising a housing enclosing at least one of the first drive and the second drive, the housing forming a thermal barrier between an interior of the housing and an exterior of the housing.

17. A testing system for determining at least one of wear and a drag force between a media and a test sample, the testing system comprising:
(a) a plurality of testing terminals, each testing terminal providing a compressive load signal and a drag force signal between a corresponding media and test sample; and
(b) a central controller operably connected to each of the testing terminals for recording at least a drag force corresponding to each of the testing terminals.

18. The testing system of claim 17, wherein the central controller controls a contact path between the media and the test sample.

19. The testing system of claim 17, wherein each testing terminal includes a reciprocating first drive and a first load sensor for applying and measuring a first force between the media and the test sample along a first axis, and a second drive and a second load sensor for applying and measuring a second compressive force between the media and the test sample along a different second axis.

20. The testing system of claim 17, wherein the central controller controls at least one a stroke length and a stroke frequency of each of the testing terminals.

21. The testing system of claim 17, wherein the central controller controls a stroke length and a stroke frequency of each of the testing terminals.

22. The testing system of claim 17, wherein the central controller adjusts the drag force by an inertial compensation.

23. The testing system of claim 17, wherein the central controller controls a contact path between the media and the test sample.

24. The testing system of claim 17, wherein the central controller controls an applied force between the media and the test sample along a contact path.

25. A testing system for determining at least one of wear and a drag force between a media and a test sample, the testing system comprising:
(a) a drive assembly providing motion along two axes of travel;
(b) a mounting arm connected to the drive assembly for movement along the two axes of travel, the mounting arm including a common fitting and a hand clamp for applying a clamping force across a portion of the common fitting; and
(c) a plurality of media mounts for engaging the mounting arm, each media mount having a cooperative fitting for engaging the common fitting in a predetermined and reproducible position, each media mount having a different media mounting interface.

26. The testing system of claim 25, further comprising a housing enclosing the drive assembly and a portion of the mounting arm, the housing forming a thermal between an interior of the housing and an exterior of the housing.

27. A method of determining at least one of wear and a drag force between a media and test sample, the method comprising:
(a) simultaneously providing reciprocating motion along a first axis between the media and the test sample at each of a plurality of testing terminals;
(b) exerting a controlled applied force along a second axis between the media and the test sample at each of the plurality of testing terminals; and
(c) providing a signal from each of the testing terminals corresponding to a drag force between the media and the test sample at each testing terminal.

28. The method of claim 27, further comprising monitoring the signal from each testing terminal to determine the drag force between the media and the test sample at each testing terminal.

29. The method of claim 27, further comprising adjusting a determination of a drag force between the media and the test sample by an amount corresponding to a mass of a media mount at a corresponding testing terminal.

30. A method of determining at least one of wear and a drag force between a media and a test sample, the method comprising:
(a) controlling each of a stroke length, a stroke frequency and a loading force for reciprocating motion between the media and the test sample; and
(b) providing a signal corresponding to a drag force between the media and the test sample.

31. The method of claim 30, further comprising calculating a drag force from the signal.

32. The method of claim 31, further comprising adjusting the calculated drag force by an inertia compensation.

33. The method of claim 30, further comprising varying at least one of the stroke length, the stroke frequency and the loading force in response to the signal corresponding to a drag force.
